(19) United States
(12) Patent Application Publication
(10) Pub. No.: US 2018/0361656 A1
(43) Pub. Date: Dec. 20, 2018

(54) METHOD OF ADDITIVE MANUFACTURING TO IMPROVE INTERLAYER ADHESION

(71) Applicant: SABIC GLOBAL TECHNOLOGIES B.V., BERGEN OP ZOOM (NL)

(72) Inventors: Lakshmikant Suryakant Powale, Delmar, NY (US); Satish Kumar Gaggar, Hoover, AL (US); Malvika Bihari, Evansville, IN (US)

(21) Appl. No.: 16/060,537

(22) PCT Filed: Dec. 8, 2016
(86) PCT No.: PCT/US2016/065498

§ 371 Date: Jun. 8, 2018

Related U.S. Application Data
(60) Provisional application No. 62/266,024, filed on Dec. 11, 2015.

(51) Int. Cl. B29C 64/118; B32B 27/08; B29C 64/40; B33Y 10/00

(52) U.S. Cl. CPC B29C 64/118; B33Y 10/00; B29C 64/40; B32B 27/08

(57) ABSTRACT

A method of making an article, the method including forming a plurality of layers of a polymer composition in a preset pattern, wherein multiple layers comprise the same polymer composition, and at least two adjacent layers comprise a first layer extruded at a first temperature A; and a second layer extruded on the first layer at a second temperature B, wherein the first and the second temperatures A and B differ by at least 5 C; and fusing the plurality of layers to provide the article. Further disclosed is an article made by the above process.

### BACKGROUND

Additive manufacturing (also known in the art as “three-dimensional or “3D” printing) is a process for the manufacture of three-dimensional objects by formation of a plurality of fused layers. Interlayer adhesion between two adjacent fused layers is a critical parameter in some applications, because it can affect a variety of properties such as mechanical strength. If a three-dimensional object does not have the desired mechanical strength, it can limit, for example, the load-bearing ability of such objects. Thus, there remains a need in the art for additive manufacturing processes that produce objects with improved interlayer adhesion.

### SUMMARY

A method of making an article comprises: melt extruding a plurality of layers comprising a polymer composition in a preset pattern, wherein multiple layers comprise the same polymer, and at least two adjacent layers of the multiple layers comprise a first layer extruded at a first temperature A; and a second layer extruded on the first layer at a second temperature B, wherein the first and the second temperatures A and B differ by at least 5° C.; and fusing the plurality of layers to provide the article.

Also described herein are the articles produced by the method described above.

An article comprises a plurality of melt-extruded layers comprising a polymer composition, wherein at least two adjacent layers comprise a first layer having a first melt temperature A; and a second layer on the first layer having a second melt temperature B, wherein the first and the second temperatures A and B differ by at least 5° C.

The above described and other features are exemplified by the following detailed description, examples, and claims.

### DETAILED DESCRIPTION

Disclosed herein are additive manufacturing methods based on melt extrusion of multiple layers of the same polymer composition. In particular, at least two adjacent layers comprising the same polymer composition are extruded at temperatures that differ by at least 5° C. In preferred embodiments, the multiple layers are extruded at temperatures that differ by at least 5° C. in a repeating temperature sequence selected to provide the desired interlayer adhesion in the article. The methods can have one or more of the following advantages. For example, the fused layers can have improved interlayer adhesion compared to the same fused layers extruded at the same temperature Improved interlayer adhesion can result in improved mechanical properties, such as tensile modulus, tensile strength, elongation at break, flexural modulus, and flexural strength of the article Articles formed by these methods can be used for increasingly demanding applications. Use of different extrusion temperatures can further minimize thermal degradation or oxidative degradation of the polymer composition during article formation. The use of different extrusion temperatures may allow improved surface aesthetics as well, for example by extruding an outer layer at a temperature that produces a more or less glossy surface, or a smoother or rougher surface.

A further advantage of using the temperature sequence as described herein is that the interlayer adhesion of the fused layers can be fine-tuned by adjusting the temperature sequence during deposition of the layers. For example, one portion of the article can be formed using a temperature sequence that results in an optimized property (such as maximum tensile strength), while another portion of the article can be formed to balance two properties (for example, tensile strength and oxidative degradation). All of the layers used to form the article can be extruded using one or more temperature sequences, or only some of the layers of the article can be extruded using one or more temperature sequences. The flexibility afforded by this process can provide articles having properties optimized for specific applications. Use of the same polymer provides a more efficient process than if different polymers or different polymer compositions were used to adjust the properties of the article.

In a specific embodiment, interlayer adhesion (also known as interlayer bonding, or interfacial strength) between adjacent layers is improved. Interlayer adhesion can be defined as the force required to separate the two adjacent layers. Interlayer adhesion can be determined, by tests suitable for determining interlayer adhesion, for example, by the lap shear test. The lap shear test is a qualitative adhesion test method that can be used to predict interlayer adhesion for 3D printed objects. The polymer composition is molded into flame bars with a thickness of 1 mm. Two flame bars of the same or different polymer composition are clamped together and placed in an oven at a temperature 3-5° C. higher than the glass transition temperature of the polymer composition. Alternatively, the test can be performed on flame bars that were adhered together when formed as adjacent layers by additive manufacturing. After cooling the flame bars, the adhesion is characterized as follows:
i. Weak, for the flame bars that can be pulled apart by hand easily,
ii. Medium, for the flame bars that are welded (due to above-mentioned heat treatment) but still can be pulled apart by hand, leaving the flame bars remaining intact, and
iii. Strong, for the flame bars that are completely welded (due to above-mentioned heat treatment) and cannot be pulled apart without breaking.

As stated above, multiple layers of the same polymer composition are extruded in a preset temperature sequence. As used herein, “multiple layers” is used in reference to the number of layers in a temperature sequence, whereas “plurality of layers” is used to refer to the total number of layers used to form the article. The number of layers in a temperature sequence is at least two, and can be up to the total number of layers used to form the article. However, the number of layers is generally less, and depends on the particular temperature sequence selected. For example, the number of layers per sequence can be 2 to 200, or 2 to 100, or 2 to 50, or 2 to 20, or 2 to 10. In some embodiments the multiple layers includes 2, 3, 4, 5, or 6 layers.

As used herein, “layer” is a term of convenience that includes any shape, regular or irregular, having at least a predetermined thickness. In some embodiments, the size and configuration of two dimensions are predetermined, and in some embodiments, the size and shape of all three dimensions of the layer is predetermined. The thickness of each layer can vary widely depending on the additive manufacturing method. In some embodiments the thickness of each layer as formed differs from a previous or subsequent layer. In some embodiments, the thickness of each layer is the same. In some embodiments the thickness of each layer as formed is 0.5 millimeters (mm) to 5 mm.

As used herein, temperatures that are the “same” differ by less than 5° C. Temperatures that are “different” differ by at least 5° C.

In the method, a first layer is extruded at a first temperature A; and a second layer is extruded on the first layer at a second temperature B. As used herein “extruded on” and “adjacent” means that the two layers directly contact each other, and no intervening layers are present. The temperature sequence is selected to provide the desired interlayer adhesion and other desired properties of the article. Where an alternating sequence of a first temperature A and second temperature B is used, the temperature sequence can be expressed as (AB)ₓ, where x is number of times the sequence is repeated and is at least 1. Other temperature sequences based on temperatures A and B can be used, for example the sequence AABBAABB, which can be expressed as (A₂B₂)ₓ, or AAABB, which can be expressed as (A₃B₂)ₓ, or ABBB, which can be expressed as (AB₃)ₓ. Thus, in an embodiment, the method comprises melt extruding the multiple layers comprising the same polymer composition at a temperature sequence (AₚB_{q})ₓ where p is the number of adjacent layers extruded at temperature A, and q is the number of adjacent layers extruded at temperature B. The variables p and q can be the same or different. In some embodiments, the variable p and q are each independently 1 to 30, preferably 1 to 20, more preferably 1 to 10, even more preferably 1 to 5. Further in the foregoing formula, x is at least 1.

All or a portion of the plurality of layers used to form the article can be extruded using a given temperature sequence. In some embodiments, all of the plurality of layers of the article are formed using the temperature sequence, for example the sequence AB. In other embodiments, a portion of the layers in the article are formed using the temperature sequence. The temperature sequence can be used to vary the properties of the article in a region of the article, for example provide increased tensile modulus or flexural modulus to the region. The number of layers formed using the temperature sequences can be represented by the formula (p+q)*x. In some embodiments, (p+q)*x is at least 1%, at least 10%, at least 25%, at least 50%, at least 80%, or at least 90% of the total number of layers in the article. Alternatively, as described above, (p+q)*x can be the total number of layers in the article.

In still her embodiments, two more different temperature sequences can be used to form an article. For example, a sequence (AB)ₓ₁ can be used to form the layers of one portion of an article, and a sequence (A₂B)ₓ₂ can be used to form the layers of a different portion of the article. The multiple layers formed by each sequence can be adjacent to each other, or separated by other layers formed at a single temperature, e.g., multiple layers formed at temperature A or B, or a third, different temperature.

In some embodiments, one or more additional layers are extruded on the second layer. The additional layers can be formed at a single temperature, as described above, or the additional layers can be formed as part of the temperature sequence. Thus, the method can further comprise melt extruding 1+n additional layers at (1+n) temperatures C(1) to C(1+n), where n is 0, or 1, or greater than 1, up to 2 less than the total number of layers in the article. When n is zero, one additional layer (a third layer) is extruded onto the second layer at temperature C(1), which may be referred to herein as “C” or “CI” for convenience. When n is one, two additional layers (third and fourth layers) are present, where the third layer is extruded on the second layer at temperature C(1), and the fourth layer is extruded onto the third layer at temperature C(2) (or “C2”). When n is 2, three additional layers (third, fourth and fifth layers) are present, where the third. layer is extruded on the second layer at temperature C(1), the fourth layer is extruded on the third layer at temperature C(2), and the fifth layer is extruded on the fourth layer at temperature C(3), and so forth. In some embodiments, n is 0, 1, 2, 3, or 4. Where three different extrusion temperatures are used in a sequence, where A is a first extrusion temperature, B is a second extrusion temperature that differs at least 5° C. from temperature A, and C is a third extrusion temperature that differs at least 5° C. from both A and B, adjacent layers can be extruded at temperatures in the sequence ABCABC . . . which can be expressed as (ABC)_{y}, or (AₚB_{q}C(1)ᵣ)_{y}, where p is 1, q is 1, and y is the number times the sequence is repeated during formation of the article.

Thus, in some embodiments, the method comprises melt extruding the multiple layers at a temperature sequence (AₚB_{q}C(1)ᵣ . . . (1+n)ₓ)_{y}, where n is the number of additional temperatures used in addition to temperature C(1), p is the number of adjacent layers extruded at temperature A, q is the number of adjacent layers extruded at temperature B, r is the number of adjacent layers extruded at temperature C(1), z is the number of layers extruded at the C(1+n) temperature. Each of p, q, r, and z can be the same or different. In some embodiments each of p, q, R, and z is independently 1 to 30, preferably 1 to 20, more preferably 1 to 10 even more preferably 1 to 5. The variable y is number of times the sequence is repeated. Preferably, (p+q+r+ . . . +z)*y is at least 1%, at least 10%, at least 25%, at least 50%, at least 80%, or at least 90% of the total number of layers in the article.

The first temperature A, the second. temperature B, and any additional temperatures C(1) C(1+n) each differ by at least 5° C. The maximum difference in temperature depends on the number of layers in the temperature sequence and the particular polymer used, in particular its flow properties. In some embodiments, each of the temperatures A, B, C(1), and each C(1+n) differ by the same amount. In other embodiments, the temperature difference between A, B, C(1), and each C(1+n) varies. The temperature difference can be 5 to 100° C., 5 to 50° C., or 5 to 30° C. For example, in the sequence (ABC)y, a first polycarbonate layer can be melt extruded at 250 to 290° C., the second polycarbonate layer can be melt extruded at a temperature 5 to 40° C. higher than the first polycarbonate layer, and a third polycarbonate layer can be extruded at a temperature 5 to 40° C. higher than the second polycarbonate layer. In the case of semi-crystalline polymers and their blends, the difference in extrusion temperatures for adjacent layers can range from 5 to 30° C., which can be adjusted based on the melt flow properties of the material. It is to be understood that the order of designation of temperatures such as A, B, and C does not imply an ascending or descending order in temperature. For example, any of A, B or C can be the highest temperature, middle temperature, or lowest temperature. For example, a first polycarbonate, layer can be melt extruded at temperature A at 250 to 290° C., the second polycarbonate layer can be melt extruded at a temperature B that is 5 to 40° C. lower than the first polycarbonate layer, and a third polycarbonate layer can be extruded at a temperature C that is 5 to 40° C. lower than the second polycarbonate layer.

In addition to the simple sequences described above, more complex sequences can be used to attain the desired properties.

Some examples of temperature sequences that can be used include

([AₚB_{q}]_{g}C1ᵣ)_{y} or

(Aₚ[B_{q}C1ᵣ]_{g})_{y}

wherein the variables p, q, r, and y are as defined above, and each g is the same or different and is the number of times the subsequence [AₚB_{q}] or [B_{q}Cᵣ] is repeated, and is at least two, for example 2 to 30, 2 to 20, 2 to 10, or 2 to 5.

Other examples of sequences that can be used include
(AₚB_{q1}C1ᵣB_{q2})_{y}
([AₚB_{q1}]_{g}C1ᵣB_{q2})_{y}
(Aₚ[B_{q1}C1ᵣ]_{g}B_{q2}_{y}
(AₚB_{q1}[C1ᵣB_{q2}]_{g})_{y}
([AₚB_{q1}C1ᵣ]_{g}B_{q2})_{y}
(Aₚ[B_{q1}C1ᵣB_{q2}]_{g})_{y}, or
([AₚB_{q1}]_{g1}[C1ᵣB_{q1}]_{g2})_{y},
   wherein the variables p, r, g and y are as defined above, q1 and q2 are the same or different and q1+q1 is the total number of layers deposited at temperature B; and each g, g1, and g2 is the same or different and is the number of times each subsequence is repeated, and is at least 2, for example 2 to 30, 2 to 20, 2 to 10, or 2 to 5.

Still other examples include
(Aₚ₁B_{q}Aₚ₂C1ᵣ)_{y},
([Aₚ₁B_{q}]_{g}Aₚ₂C1ᵣ)_{y}
(Aₚ₁[B_{q}Aₚ₂]_{g}C1ᵣ)_{y}
(Aₚ₁B₁[Aₚ₂C1ᵣ]_{g})_{y}
([Aₚ₁B_{q}Aₚ₂]_{g}C1ᵣ)_{y}
(Aₚ₁[B_{q}Aₚ₂C1ᵣ]_{g})_{y} or
([Aₚ₁B_{q}]_{g1}[Aₚ₂C1ᵣ)]_{g2})_{y},
   wherein the variables q, r, g, g1, g2, and y are as defined above, p1 and p2 can be the same or different and p1+p2 is the total number of layers deposited at temperature A.

Still other examples include
(AₚB_{q}C1ᵣ₁[B_{q}C2₂]_{g})_{y}, or
(AₚB_{q}C1ᵣ[BₛC2₂A_{q}]_{g})_{y}, or
(AₚB_{q}C1ᵣ[BₛC2ₛB_{q}]_{g})_{y}, or
(Aₚ₁B_{q}C1ᵣ[B_{q}AₜB₁)]_{g})_{y}, or
(Aₚ₁B_{q}C1ᵣ[B_{q}AₜB_{q}]_{g})_{y}, or
(AₚB_{q}C1ᵣ[B_{q}AₜC2ₛ]_{g})_{y},
   wherein the variables p, q, r, s, g, and y are as defined above and u is the number of layers deposited at temperature C2.

As stated above, the temperature sequence and specific temperatures are selected to provide the desired interlayer adhesion and other desired properties of the article. For example, and without being bound by theory, it is believed that polymer layers extruded at higher temperatures can have improved interlayer adhesion with adjacent layers, but can also be more susceptible to thermal oxidation or degradation due to the higher extrusion temperatures. Thus, where A<B, in some embodiments, a sequence such as (AₚB_{q})ₓ where p<q can significantly improve interlayer adhesion, and still have acceptable thermal degradation; a sequence such as (AB)ₓ can optimize a balance between interlayer adhesion and thermal degradation; and a sequence such as (AₚB_{q})ₛ where p>q can have improved interlayer adhesion while not significantly increasing thermal degradation. In the foregoing examples, specific sequences that can be used include (A₂B)ₓ, (A₃B_{q})ₓ, (A₄B)ₓ, (A₅B)ₓ, (AB)ₓ, (AB₂)ₓ, (AB₃)ₓ, (A₂B₄)ₓ, and (AB₅)ₓ.

In other embodiments, improved physical properties can be obtained using a gradient of temperatures. Where A<B<C1<C2, sequences of this type include (AₚB_{q1}CᵣB_{q2})_{y} and (AₚB_{q1}C1ᵣC2ᵤC1ᵣB_{q2})_{y}. Again, the number of layers deposited at each temperature can be adjusted to obtain the desired properties, for example in some embodiments by increasing the fraction of layers deposited at a lower temperature (A) to maintain good thermal degradation, e.g., (AₚB_{q}CᵣB_{q2})_{y} where p>q1, r, and q2, or ([AₚB_{q1}]_{g}CᵣB_{q2})_{y} r=p=q1=q2. Balanced properties can be obtained in some embodiments by using approximately equal fractions, e.g., (AₚB_{q1}CᵣB_{q2})_{y} where p=q1=r=q2. Significantly improved thermal adhesion can be obtained in some embodiments by increasing the fraction of layers deposited at higher temperatures, e.g., (AₚB_{q1}C1ᵣB_{q2})_{y} where r>p+q1+q2, or (Aₚ[B_{q1}C1ᵣ]_{g}B_{q2})_{y} where p=q1=r=q2. In the foregoing examples, specific sequences that can be used include (A₃BCB)_{y}, (A₂BCB)_{y}, ([AB]₂CB)_{y}, (A₂B₂CB₂)_{y}, (AB₂CB₂)_{y}, (ABCB)_{y}, (AB₂C₂B₂)_{y}, (ABC₂B)_{y}, (ABC₃B)_{y}, and (A[BC]₂B)_{y}.

Still other specific sequences that can be used where A<B<C1 include sequences of the formula (Aₚ₁B_{q1}Cᵣ₁B_{q2}Aₚ₂Cᵣ₂)_{y} or (Aₚ₁Cᵣ₁B_{q1}Cᵣ₂B₁₂Cᵣ₂)_{y} wherein in each formula each p1, q1, r1, p2, q2, and r2 are the same or different, and are 1 to 30, 1 to 20, 1 to 10, or 1 to 4, or 1 to 2. Specific formulas of this type include (AB₂CB₂AC)_{y} and ACBCBC)_{y}.

In still other embodiments where A<B<C, it can be desirable for the first layer to be deposited at a higher temperature, for example to improve temporary bonding to the build surface or print pad of the additive manufacturing assembly. Such sequences can include sequences of the type (Cᵣ₁B_{q1}Aₚ₁B_{q2})ₙ, or (Cᵣ₁B_{q1}Aₚ₁B_{q})ₙ, or (Cᵣ₁B_{q1}Cᵣ₂Aₚ₁)ₙ, or (Cᵣ₁B_{q1}Aₚ₁CᵣAₚ₂B_{q2})ₙ, and the like, wherein in each formula each p1, q1, r1, p2, q2, and r2 are the same or different, and are 1 to 30, 1 to 20, 1 to 10, or 1 to 4, or 1 to 2. Specific formulas of this type include (CBAB)_{y}, (CB₂A₂B)_{y}, (CB₂CA)_{y}, and (CBBACAB₂)_{y}.

In some embodiments the printing process starts with a layer extruded at the highest temperature of the pattern, which can help to ensure that better temporary bonding of the object to the build surface or print pad. For example, in an embodiment in which A is the highest temperature, B is a middle temperature, and C is the lowest temperature, the layers could be extruded in sequences such as a repeating ABC pattern, a repeating ABBCBB pattern, or other similar patterns starting with a layer extruded at the highest temperature of the sequence.

In some embodiments the layers are extruded to minimize the number of layers extruded at the highest temperatures.

As stated above, a three dimensional article is manufactured by extruding a plurality of layers in a preset pattern by an additive manufacturing. The material extrusion techniques include techniques such as fused deposition modeling and fused filament fabrication as well as others as described in ASTM F2792-12a. Any additive manufacturing process can be used, provided that the process allows formation of at least two adjacent layers extruded at temperatures that differ by at least 5° C. In some embodiments, more than two adjacent layers are extruded at temperatures that differ by at least 5° C. The methods herein can be used for fused deposition modelling (FDM), Big Area Additive Manufacturing (BAAM), ARBURG plastic free forming technology, and other additive manufacturing methods.

In fused material extrusion techniques, an article can be produced by heating a thermoplastic material to a flowable state that can be deposited to form a layer. The layer can have a predetermined shape in the x-y axis and a predetermined thickness in the z-axis. The flowable material can be deposited as roads as described above, or through a die to provide a specific profile. The layer cools and solidifies as it is deposited. A subsequent layer of melted thermoplastic material fuses to the previously deposited layer, and solidifies upon a drop in temperature. Extrusion of multiple subsequent layers builds the desired shape.

The total number of layers in the article can vary significantly. Generally but not always, at least 20 layers are present. The maximum number of layers can vary greatly, determined, for example, by considerations such as the size of the article being manufactured, the technique used, the capabilities of the equipment used, and the level of detail desired in the final article. For example, 20 to 100,000 layers can be formed, or 50 to 50,000 layers can be formed. The plurality of layers in the predetermined pattern is fused to provide the article. Any method effective to fuse the plurality of layers during additive manufacturing can be used. In some embodiments, the fusing occurs during formation of each of the layers. In some embodiments the fusing occurs while subsequent layers are formed, or after all layers are formed.

The preset pattern can be determined from a three-dimensional digital representation of the desired article as is known in the art and described in further detail below. In particular, an article can be formed from a three-dimensional digital representation of the article by depositing the flowable material as one or more roads on a substrate in an x-y plane to form the layer. The position of the dispenser (e.g., a nozzle) relative to the substrate is then incremented along a z-axis (perpendicular to the x-y plane), and the process is then repeated to form an article from the digital representation. The dispensed material is thus also referred to as a “modeling material” as well as a “build material.”

In some embodiments the layers are extruded from two or more nozzles. In some embodiments the layers are extruded such that each of the layers extruded at temperatures that differ by less than 5° C. are extruded from the same nozzle, and any layers that are extruded at temperatures that differ by at least 5° C. are extruded from different nozzles. For example, in a pattern of three temperatures A, B, and C, one nozzle extrudes polymer only at the A temperature, one nozzle different from the A nozzle extrudes polymer only at the B temperature, and one nozzle different from the A and B nozzles extrudes polymer only at the C temperature.

In some embodiments, each nozzle extrudes polymer at only one of the temperatures (for example, A, B, or C) but there can be multiple nozzles for each temperature. If multiple nozzles are used, some nozzles can be used to extrude polymer at lower temperatures and other nozzles can be used to extrude polymer at higher temperatures. If multiple nozzles are used, the method can produce the product objects faster than methods that use a single nozzle, and can allow increased flexibility in terms of using different polymers or blends of polymers, different colors, or textures, and the like.

In some embodiments polymer layers at temperatures that differ by at least 5° C. are extruded from the same nozzle. This can be accomplished by dynamically and rapidly changing the temperature of the nozzle.

In some embodiments a support material as is known in the art can optionally be used to form a support structure. In these embodiments, the build. material and the support material can be selectively dispensed during manufacture of the article to provide the article and a support structure. The support material can be present in the form of a support structure, for example a scaffolding, that can be mechanically removed or washed away when the layering process is completed to the desired degree. For some embodiments, the build structure and the support structure of the article formed can be extruded at temperatures that differ by at least 5° C. In other embodiments, at least one support structure layer and one adjacent build structure layer are extruded at temperatures that differ by at least 5° C.

Systems for material extrusion are known. An exemplary material extrusion additive manufacturing system includes a build chamber and a supply source for the thermoplastic material. The build chamber includes a build platform, a gantry, and a dispenser for dispensing the thermoplastic material, for example an extrusion head. The build platform is a platform on which the article is built, and desirably moves along a vertical z-axis based on signals provided from a computer-operated controller. The gantry is a guide rail system that can be configured to move the dispenser in a horizontal x-y plane within the build chamber, for example based on signals provided from a controller. The horizontal x-y plane is a plane defined by an x-axis and a y-axis where the x-axis, the y-axis, and the z-axis are orthogonal to each other. Alternatively the platform can be configured to move in the horizontal x-y plane and the extrusion head can be configured to move along the z-axis. Other similar arrangements can also be used such that one or both of the platform and extrusion head are moveable relative to each other. The build platform can be isolated or exposed to atmospheric conditions.

In some embodiments, the support structure can be made purposely breakable, to facilitate breakage where desired. For example, the support material can have an inherently lower tensile or impact strength than the build material. In other embodiments, the shape of the support structure can be designed to increase the breakability of the support structure relative to the build structure.

For example, in some embodiments, the build material can be made from a round print nozzle or round extrusion head. A round shape as used herein means any cross-sectional shape that is enclosed by one or more curved lines. A round shape includes circles, ovals, ellipses, and the like, as well as shapes having an irregular cross-sectional shape. Three dimensional articles formed from round shaped layers of build material can possess strong structural strength. In other embodiments, the support material for the articles can made from a non-round print nozzle or non-round extrusion head. A non-round shape means any cross-sectional shape enclosed by at least one straight line, optionally together with one or more curved lines. A non-round shape can include squares, rectangles, ribbons, horseshoes, stars, T head shapes, X shapes, chevrons, and the like. These non-round shapes can render the support material weaker, brittle and with lower strength than round shaped build material.

In some embodiments, the lower density support materials can be made from a non-round print nozzle or round extrusion head and be extruded at temperatures that do not differ by at least 5° C. These non-round shaped lower density support materials can be easily removed from build materials, particularly higher density round shaped build materials that have been extruded at temperatures that do not differ by at least 5° C.

In some embodiments the thermoplastic material is supplied a melted form to the dispenser. The dispenser can be configured as an extrusion head. The extrusion head can deposit the thermoplastic composition as an extruded material strand to build the article. Examples of average diameters for the extruded material strands can be from 1.27 millimeters (0.050 inches) to 3.0 millimeters (0.120 inches). Depending on the type of thermoplastic material, the thermoplastic material can be extruded at a temperature of 200 to 450° C. In some embodiments the thermoplastic material an be extruded at a temperature of 300 to 415° C. The layers can be deposited at a build temperature (the temperature of deposition of the thermoplastic extruded material) that is 50 to 200° C. lower than the extrusion temperature. For example, the build temperature can be 15 to 250° C. In some embodiments the thermoplastic material is extruded at a temperature of 200 to 450° C., or 300 to 415° C., and the build temperature is maintained at ambient temperature.

A wide variety of polymer compositions can be used, provided that the polymer compositions can be extruded at different temperatures. Preferably the polymers are those known as thermoplastic polymers. Examples of thermoplastic polymers that can be used include polyacetals (e.g., polyoxyethylene and polyoxymethylene), poly(C₁₋₆ alkyl)acrylates, polyacrylamides, polyamides, (e.g., aliphatic polyamides, polyphthalamides, and polyaramides), polyamideimides, polyanhydrides, polyarylates, polyarylene ethers polyphenylene ethers), polyarylene sulfides (e.g., polyphenylene sulfides), polyarylenesulfone (e.g., polyphenylene sulfones), polybenzothiazoles, polyhenzoxazoles, polycarbonates (including polycarbonate copolymers such as polycarbonate-siloxanes, polycarbonate-esters, and polycarbonate-ester-siloxanes), polyesters (e.g., polyethylene terephthalates, polybutylene terephthalates, polyarylates, and polyester copolymers such as polyester-ethers), polyetheretherketones, polyetherimides (including copolymers such as polyetherimide-siloxane copolymers), polyetherketoneketones, polyetherketones, polyethersulfones, polyimides (including copolymers such as polyimide-siloxane copolymers), poly(C₁₋₆ alkyl)methacrylates, polymethacrylamides, polynorbornenes (including copolymers containing norbornenyl units), polyolefins (e.g., polyethylenes, polypropylenes, polytetrafluoroethylenes, and their copolymers, for example ethylene-alpha-olefin copolymers), polyoxadiazoles, polyoxymethylenes, polyphthalides, polysilazanes, polysiloxanes, polystyrenes (including copolymers such as acrylonitrile-butadiene-styrene (ABS) and methyl methacrylate-butadiene-styrene (MBS)), polysulfides, polysulfonamides, polysulfonates, polysulfones, polythioesters, polytriazines, polyureas, polyurethanes, polyvinyl alcohols, polyvinyl esters, polyvinyl ethers, polyvinyl halides, polyvinyl ketones, polyvinyl thioethers, polyvinylidene fluorides, or the like, or a combination comprising at least one of the foregoing thermoplastic polymers. Polyacetals, polyamides (nylons), polycarbonates, polyesters, polyetherimide, polyolefins, and polystyrene copolymers such as acrylonitrile butadiene styrene (ABS), are especially useful in a wide variety of articles, have good processabitity, and are recyclable.

Examples of thermoplastic polymers that can be used include polyacetals, polyacrylates, polyacrylics, polyamideimides, polyamides, polyanhydrides, polyaramides, polyarylates, polyarylene ethers (e.g., polyphenylene ethers), polyarylene sulfides (e.g., polyphenylene sulfides), polyarylsulfones, polycarbonates (including polycarbonate copolymers such as polycarbonate-siloxanes, polycarbonate-esters, and polycarbonate-ester siloxanes), polyesters (e.g. polyethylene terephthalates and polybutylene terephthalates), polyetheretherketones, polyetherimides (including copolymers such as polyetherimide-siloxane copolymers), polyetherketoneketones, polyetherketones, polyethersulfones, polyimides (including copolymers such as polyimide-siloxane copolymers), polyolefins (e.g., polyethylenes, polypropylenes, polytetraftuoroethylenes, and their copolymers), polyphthalides, polysilazanes, polysiloxanes, polystyrenes (including copolymers such as acrylonitrile-butadiene-styrene (ABS) and methyl methacrylate-butadiene-styrene (MBS)), polysulfides, polysulfonamides, polysulfonates, polythioesters, polytriazines, polyureas, polyvinyl alcohols, polyvinyl esters, polyvinyl ethers, polyvinyl halides, polyvinyl ketones, polyvinylidene fluorides, polyvinyl aromatics, polyarylene sulfrmes, polyaryl ether ketones, poly(phenylene oxide), poly(methyl methacrylate), styrene-acrylonitrile, poly(ethylene oxide), epichlorohydrin polymer, polylactic acid, polyglycolic acid, poly-3-hydroxybutyrate, polyhydroxyalkanoate, thermoplastic starch, cellulose ester, silicones, or the like, or a combination comprising at least one of the foregoing thermoplastic polymers. In some embodiments, polyacetals, polyamides (nylons), polycarbonates, polyesters, polyetherimides, polyolefins and polystyrene copolymers such as acrylonitrile butadiene styrene, are especially useful in a wide variety of articles, have good processability, and are recyclable.

In some embodiments the polymer composition composition comprises a polystyrene, poly(phenylene oxide), poly(methyl methacrylate), styrene-acrylonitrile, poly(ethylene oxide), epichlorohydrin polymer, polycarbonate, acrylonitrile-butadiene-styrene, polyetherimide, polyimide, or a combination comprising at least one of the foregoing thermoplastic polymers.

Exemplary polycarbonates are described, for example, in WO 2013/175448 A1, US 2014/0295363, and WO 2014/072923. Polycarbonates are generally manufactured from bisphenol compounds such as 2,2-bis(4-hydroxyphenyl) propane (“bisphenol-A” or “BPA”), 3,3-bis(4-hydroxyphenyl)phthalimidine, 1,1-bis(4-hydroxy-3-methylphenyl)cyclohexane, or 1,1-bis(4-hydroxy-3-methylphenyl)-3,3,5-trimethylcyclohexane, or a combination comprising at least one of the foregoing bisphenol compounds can also be used.

In a specific embodiment, the polycarbonate is a homopolymer derived from BPA, for example a linear homopolycarbonate containing bisphenol A carbonate units, such as that available under the trade name LEXAN from the Innovative Plastics division of SABIC. A branched, cyanophenol end-capped bisphenol A homopolycarbonate produced via interfacial polymerization, containing 3 mol % 1,1,1-tris(4-hydroxyphenyl)ethane (THPE) branching agent, commercially available under the trade name CFR from the Innovative Plastics division of SABIC can be used.

In other embodiments, the polycarbonate is a copolymer derived from BPA and another bisphenol or dihydroxy aromatic compound such as resorcinol (a “copolycarbonate”). A specific copolycarhonate includes bisphenol A and bulky bisphenol carbonate units, i.e., derived from bisphenols containing at least 12 carbon atoms, for example 12 to 60 carbon atoms or 20 to 40 carbon atoms. Examples of such copolycarbmates include copolycarbonates comprising bisphenol A carbonate units and 2-phenyl-3,3″-bis(4-hydroxyphenyl) phthalimidine carbonate units (a BPA-PPPBP copolymer. commercially available under the trade designation XHT from the Innovative Plastics division of SABIC); a copolymer comprising bisphenol A carbonate units and 1,1-bis(4-hydroxy-3-methylphenyl)cyclohexane carbonate units (a BPA-DMBPC copolymer) commercially available under the trade designation DMC from the Innovative Plastics division of SABIC; and a copolymer comprising bisphenol A carbonate units and isophorone bisphenol carbonate units (available, for example, under the trade name APEC from Bayer.

Other polycarbonate copolymers include poly(siloxane-carbonate)s. poly(ester-carbonate)s, poly(carbonate-ester-siloxane)s, and poly(aliphatic ester-carbonate)s. Specific poly(carbonate-siloxane)s comprise bisphenol A carbonate units and siloxane units, for example blocks containing 5 to 200 dimethylsiloxane units, such as those commercially available under the trade name EXL from the Innovative Plastics division of SABIC. Examples of poly(ester-carbonate)s includes poly(ester-carbonate)s comprising bisphenol A carbonate units and isophthalate-terephthalate-bisphenol A ester units, also commonly referred to as poly(carbonate-ester)s (PCE) or poly(phthalate-carbonate)s (PPC), depending on the relative ratio of carbonate units and ester units. Other polyester-carbonates include containing bisphenol A carbonate units and isophthalate/terephthalate esters of resorcinol, such as those available under the trade name SLX the Innovative Plastics division of SABIC is a poly(ester-carbonate-siloxane) comprising bisphenol A carbonate units, isophthalate-terephthalate-bisphenol A ester units, and siloxane units, for example blocks containing 5 to 200 dimethylsiloxane units, such as those commercially available under the trade name FST from the Innovative Plastics division of SABIC. Poly(aliphatic ester-carbonate)s can be used, such as those comprising bisphenol A carbonate units and sebacic acid-bisphenol A ester units, for example those commercially available under the trade name LEXAN HFD from the Innovative Plastics division of SABIC.

The thermoplastic material can include various additives ordinarily incorporated into polymer compositions of this type, with the proviso that any additives are selected so as to not significantly adversely affect the desired properties of the thermoplastic composition, in particular the melt flow index. Such additives can be mixed at a suitable time during the mixing of the components for forming the composition. Additives include nucleating agents, fillers, reinforcing agents, antioxidants, heat stabilizers, light stabilizers, ultraviolet (UV) light stabilizers, plasticizers, lubricants, mold release agents, surfactants, antistatic agents, colorants such as titanium dioxide, carbon black, and organic dyes, surface effect additives, radiation stabilizers, flame retardants, and anti-drip agents. A combination of additives can be used, for example a combination of a heat stabilizer and ultraviolet tight stabilizer. In general, the additives are used in the amounts generally known to be effective. For example, the total amount of the additives (other than any impact modifier, filler, or reinforcing agents) can be 0.01 to 5 wt. %, based on the total weight of the thermoplastic material.

In other embodiments, an exterior shell (or other component) can be formed from thermoplastic materials and then used as a substrate for the additive manufacturing process. In other embodiments, a shell can be partially or completely fitted by forming a core at least in part by additive manufacturing as described herein. The core accordingly includes at least two adjacent layers extruded at temperatures that differ by at least 5° C. It is also contemplated that the core of an article can be formed first by additive manufacturing as described herein, and an exterior shell (or other component) can then be formed or attached. The exterior shell or other component can also be formed by additive manufacturing, for example using material extrusion methods.

Once formed, in some embodiments a surface of the article can be shaped, smoothed, or otherwise manipulated using a heated tool such as a knife, paddle, or molding tool. The surface can be an intermediate layer or a final layer. In other embodiments, a surface of the article can be smoothed or manipulated by applying a solvent for the layer or a varnish. Application of the solvent or the varnish can occur by dipping, spraying, brushing, or other appropriate method. Varnish, as used herein, describes a polymer precursor or combination of polymer precursors that can be applied and then polymerized.

Forming of articles with at least two adjacent layers extruded at temperatures that differ by at least 5° C. can allow the different layers to have different properties, for example different stiffnesses, different wear, different impact, colors, and the like, based on a desired application.

In some embodiments the printed object produced by the method of the disclosure has improved mechanical characteristics when compared with objects made by a method in which all layers are extruded at temperatures that do not differ by at least 5° C. Improved characteristics can include tensile modulus, tensile strength, elongation at break, flexural modulus, and flexural strength.

The present invention is further illustrated by the following Embodiments.

### Embodiment 1

A method of making an article comprises: melt extruding a plurality of layers comprising a polymer composition in a preset pattern, wherein multiple layers comprise the same polymer, and at least two adjacent layers of the multiple layers comprise a first layer extruded at a first temperature A; and a second layer extruded on the first layer at a second temperature B, wherein the first and the second temperatures A and B differ by at least 5° C.; and fusing the plurality of layers to provide the article.

### Embodiment 2

The method of Embodiment 1, further comprising melt extruding (1+n) additional layers at (1+n) different temperatures C(1) to C(1+n), wherein n is zero, 1, or greater than 1; and each of the (1+n) different temperatures differ from temperatures A, B, and each other by at least 5° C.

### Embodiment 3

The method of Embodiment 1, comprising melt extruding the multiple layers comprising the same polymer composition at a temperature sequence (AₚB_{q})ₓ wherein p is the number of adjacent layers extruded at temperature A and is 1 to 30, preferably 1 to 20, more preferably 1 to 10, even more preferably 1 to 5; q is the number of adjacent layers extruded at temperature B, and is 1 to 30, preferably 1 to 20, more preferably 1 to 10, even more preferably 1 to 5; and x is number of times the sequence is repeated and is at least 1, preferably wherein (p+q)*x is at least 1%, at least 10%, at least 25%, at least 50%, at least 80%, or at least 90% of the total number of layers in the article.

### Embodiment 4

The method of Embodiment 2, wherein p and q are each 1.

### Embodiment 5

The method of Embodiment 2, wherein p and q are not the same.

### Embodiment 6

The method of Embodiment 2, wherein in the temperature sequence (AₚB₁), x is greater than 1, and the value of p varies, or the value of q varies, or both the value of p and the value of q vary.

### Embodiment 7

The method of any one or more of Embodiments 1 to 6, comprising melt extruding the multiple layers wherein at least one layer is extruded at a temperature C(1), wherein the temperature C(1) varies from the first and the second temperatures A and B by at least 5° C.

### Embodiment 8

The method of Embodiment 7, comprising melt extruding the multiple layers at a temperature sequence (AₚB_{q}C(1)ᵣ)_{y}, wherein p is the number of adjacent layers extruded at temperature A and is 1 to 30, preferably 1 to 20, more preferably 1 to 10, even more preferably 1 to 5,q is the number of adjacent layers extruded at temperature B, and is 1 to 30, preferably 1 to 20, more preferably 1 to 10, even more preferably 1 to 5, r is the number of adjacent layers extruded at temperature C(1), and is 1 to 30, preferably 1 to 20, more preferably 1 to 10, even more preferably 1 to 5, and y is number of times the sequence is repeated, preferably wherein (p+q+r)*y is at least 1%, at least 10%, at least 25%, at least 50%, at least 80%, or at least 90% of the total number of layers in the article.

### Embodiment 9

The method of Embodiment 7, comprising melt extruding the plurality of the layers at a temperature sequence (AₚB_{q}C(1)ᵣB_{q})_{y}, wherein either temperature B is higher than temperature A and lower than temperature C(1), or temperature B is lower than temperature A and higher than temperature C(1).

### Embodiment 10

The method of any one or more of Embodiments 1 to 9, comprising melt extruding a plurality of the layers at four or more different temperatures, wherein each temperature varies from at least one other temperature by at least 5° C.

### Embodiment 11

The method of any one or more of Embodiments 1 to 10, wherein each of the temperatures differs from at least one other temperature by 5 to 100° C., or by 5 to 50° C., or by 5 to 30° C.

### Embodiment 12

The method of any one or more of Embodiments 1 to 11, wherein each of the layers extruded at the same temperature is extruded through the same nozzle and each of the layers extruded at a different temperature is extruded through a different nozzle.

### Embodiment 13

The method of any one or more of Embodiments 1 to 12, wherein the polymer composition comprises a polyacetal, polyacrylate, polyacrylic, polyamide, polyamideimide, polyanhydride, polyarylate, polyarylene ether, polyarylene sulfide, polybenzoxazote, polycarbonate, polyester, polyetheretherketone, polyetherimide, polyetherketoneketone, polyetherketone, polyethersulfone, polyimide, polymethacrylate, polyolefin, polyphthalide, polysilazane, polysiloxane, polystyrene, polysulfide, polysulfonamide, polysulfonate, polythioester, poi ytriazine, polyurea, polyurethane, polyvinyl alcohol, polyvinyl ester, polyvinyl ether, polyvinyl halide, polyvinyl ketone, polyvinylidene fluoride, polyvinyl aromatic, polysulfone, polyarylene sulfone, polyaryl ether ketone, polylactic acid, polyglycolic acid, poly-3-hydroxybutyrate, polyhydroxyalkanoate, thermoplastic starch, cellulose ester, or a combination comprising at least one of the foregoing polymer compositions.

### Embodiment 14

The method of any one or more of Embodiments 1 to 13, wherein the polymer composition comprises a polystyrene, poly(phenylene oxide), poly(methyl methacrylate), styrene-acrylonitrile, poly(ethylene oxide), epichlorohydrin polymer, polycarbonate homopolymer, copolycarbonate, poly(ester-carbonate), poly(carbonate-siloxane), poly(carbonate-ester-siloxane), acrylonitrile-butadiene-styrene, polyetherimide, polyimide, or a combination comprising at least one of the foregoing polymers,

### Embodiment 15

The method of any of Embodiments 1 to 14, wherein the melt extruding of a plurality of layers comprises melt extruding a plurality of layers comprising a build material and melt extruding a plurality of layers comprising a support material.

### Embodiment 16

The method of any of Embodiments 1 to 15, wherein the first layer extruded on a build surface or print pad is extruded at the highest temperature used in the process.

### Embodiment 17

The method of any of Embodiments 1 to 16, wherein the first layer extruded on a build surface or print pad is extruded at a temperature which produces bonding of the part to the build surface or print pad during the printing process sufficient to prevent detachment from the build surface or print pad during the printing process.

### Embodiment 18

The method of any one or more of Embodiments 1 to 17, wherein at least two adjacent layers extruded at different temperatures have improved interlayer adhesion compared to adjacent layers extruded at the same temperature, wherein the improvement is at least 10% as measured by the lap shear test.

### Embodiment 19

An article made by the method of any one or more of Embodiments 1 to 18.

### Embodiment 21

An article, comprising: a plurality of melt-extruded layers comprising a polymer composition, wherein at least two adjacent layers comprise a first layer extruded at a first melt temperature A; and a second layer on the first layer extruded at a second melt temperature B, wherein the first and the second temperatures A and B differ by at least 5° C.

### Embodiment 22

The article of Embodiment 2:2, further comprising (1+n) additional layers extruded at (1+n) different temperatures C(1) to C(1+n), wherein n is zero, 1, or greater than 1; and each of the (1−n) different temperatures differ from temperatures A, B, and each other by at least 5° C.

### Embodiment 23

The article of Embodiment 23, wherein the multiple layers comprising the same polymer composition extruded at a temperature sequence (AₚB_{q})ₓ wherein p is the number of adjacent layers extruded at temperature A and is 1 to 30, preferably 1 to 20, more preferably 1 to 10, even more preferably 1 to 5; q is the number of adjacent layers extruded at temperature B, and is 1 to 30, preferably 1 to 20, more preferably 1 to 10, even more preferably 1 to 5; and x is number of times the sequence is repeated and is at least 1, preferably wherein (p+q)*x is at least 1%, at least 10%, at least 25%, at least 50%, at least 80%, or at least 90% of the total number of layers in the article.

The compositions, methods, and articles can alternatively comprise, consist of, or consist essentially of, any appropriate components or steps herein disclosed. The compositions, methods, and articles can additionally, or alternatively, be formulated so as to be devoid, or substantially free, of any steps, components, materials, ingredients, adjuvants, or species that are otherwise not necessary to the achievement of the function andlor objectives of the compositions, methods, and articles.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. Reference throughout the specification to “an embodiment”, “another embodiment” “some embodiments”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

Unless defined otherwise, technical and scientific terms used herein have the same meaning as is commonly understood by one of skill in the art to which this invention belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A method of making an article, the method comprising:
melt extruding a plurality of layers comprising a polymer composition in a preset pattern, at least two adjacent layers of the multiple layers comprise wherein multiple layers comprise the same polymer, and a first layer extruded at a first temperature A; and a second layer extruded on the first layer at a second temperature B, wherein the first and the second temperatures A and B differ by at least 5° C.; and
fusing the plurality of layers to provide the article.

2. The method of claim 1, further comprising melt extruding (1+n) additional layers of the multiple layers at (1+n) different temperatures C(1) to C(1+n), wherein n is zero, 1, or greater than 1; and each of the (1+n) different temperatures differ from temperatures A, B, and each other by at least 5° C.

3. The method of claim 1, comprising melt extruding the multiple layers comprising the same polymer composition at a temperature sequence (AₚB_{q})ₓ wherein p is the number of adjacent layers extruded at temperature A and is 1 to 30; q is the number of adjacent layers extruded at temperature B, and is 1 to 30; and x is number of times the sequence is repeated and is at least 1.

4. The method of claim 2, wherein p and q are each 1.

5. The method of claim 2, wherein p and q are not the same.

6. The method of claim 2, wherein in the temperature sequence (AₚB_{q})ₓ, x is greater than 1, and the value of p varies, or the value of q varies, or both the value of p and the value of q vary.

7. The method of claim 1, comprising melt extruding the multiple layers wherein at least one layer is extruded at a temperature C(1), wherein the temperature C(1) varies from the first and the second temperatures A and B by at least 5° C.

8. The method of claim 7, comprising melt extruding the multiple layers at a temperature sequence (AₚB_{q}C(1)ᵣ)_{y}, wherein
p is the number of adjacent layers extruded at temperature A and is 1 to 30,
q is the number of adjacent layers extruded at temperature B, and is 1 to 30
r is the number of adjacent layers extruded at temperature C(1), and is 1 to 30, and
y is number of times the sequence is repeated.

9. The method of claim 7, comprising melt extruding the plurality of the layers at a temperature sequence (AₚB_{q}C(1)ᵣB_{q})_{y}, wherein either temperature B is higher than temperature A and lower than temperature C(1), or temperature B is lower than temperature A and higher than temperature C(1).

10. The method of claim 1, comprising melt extruding a plurality of the layers at four or more different temperatures, wherein each temperature varies from at least one other temperature by at least 5° C.

11. The method of claim 1, wherein each of the temperatures differs from at least one other temperature by 5 to 100° C. 5 to 50° C., or by 5 to 30° C.

12. The method of claim 1, wherein each of the layers extruded at the same temperature is extruded through the same nozzle and each of the layers extruded at a different temperature is extruded through a different nozzle.

13. The method of claim 1, wherein
the polymer composition comprises a polyacetal, polyacrylate, polyacrylic, polyamide, polyamideimide, polyanhydride, polyarylate, polyarylene ether, polyarylene sulfide, polybenzoxazole, polycarbonate, polyester, polyetheretherketone, polyetherimide, polyetherketoneketone, polyetherketone, polyethersulfone, polyimide, polymethacrylate, polyolefin, polyphthalide, polysilazane, polysiloxane, polystyrene, polysulfide, polysulfonamide, polysulfonate, polythioester, polytriazine, polyurea, polyurethane, polyvinyl alcohol, polyvinyl ester, polyvinyl ether, polyvinyl halide, polyvinyl ketone, polyvinylidene fluoride, polyvinyl aromatic, polysulfone, polyarylene sulfone, polyaryl ether ketone, polylactic acid, polyglycolic acid, poly-3-hydroxybutyrate, polyhydroxyalkanoate, thermoplastic starch, cellulose ester, or a combination comprising at least one of the foregoing polymer compositions.

14. The method of claim 1, wherein the polymer composition comprises a polystyrene, poly(phenylene oxide), poly(methyl methacrylate), styrene-acrylonitrile, poly(ethylene oxide), epichlorohydrin polymer, polycarbonate homopolymer, copolycarbonate, poly(ester-carbonate), poly(carbonate-siloxane), poly(carbonate-ester-siloxane), acrylonitrile-butadiene-styrene, polyetherimide, polyimide, or a combination comprising at least one of the foregoing polymers.

15. The method of claim 1, wherein the melt extruding of a plurality of layers comprises melt extruding a plurality of layers comprising a build material and melt extruding a plurality of layers comprising a support material.

16. The method of claim 1, wherein the first layer extruded on a build surface or print pad is extruded at the highest temperature used in the process.

17. The method of claim 1, wherein the first layer extruded on a build surface or print pad is extruded at a temperature which produces bonding of the part to the build surface or print pad during the printing process sufficient to prevent detachment from the build surface or print pad during the printing process.

18. The method of claim 1, wherein at least two adjacent layers extruded at different temperatures have improved interlayer adhesion compared to adjacent layers extruded at the same temperature, wherein the improvement is at least 10% as measured by the lap shear test.

19. An article made by the method of claim 1.

20. An article, comprising:
a plurality of melt-extruded layers comprising a polymer composition, wherein at least two adjacent layers comprise
a first layer having a first melt temperature A; and
a second layer on the first layer having a second melt temperature B, wherein the first and the second temperatures A and B differ by at least 5° C.
